(19) United States
(12) Patent Application Publication
(10) Pub. No.: US 2008/0095999 A1
(43) Pub. Date: Apr. 24, 2008

(54) Protective Film For Polarizing Plate, Method For Preparation Thereof, Polarizing Plate With Antireflection Function, And Optical Article

(76) Inventors: Masanori Yoshihara, Tokyo (JP); Tetsuya Toyoshima, Tokyo (JP); Yasumasa Yoshitomi, Tokyo (JP)

Correspondence Address: BIRCH STEWART KOLASCH & BIRCH, PO BOX 747, FALLS CHURCH, VA, 22040-0747, US

(21) Appl. No.: 10/549,915

(22) PCT Filed: Mar. 26, 2004
(86) PCT No.: PCT/JP04/04241

§ 371 Date: Jul. 16, 2007

(30) Foreign Application Priority Data
Mar. 31, 2003 (JP) 2003-097031

(51) Int. Cl. B32B 33/00; B05D 5/06; C25D 7/08

(52) U.S. Cl. 428/220; 205/116; 427/163.1; 427/523; 427/525; 427/529

(57) ABSTRACT

A protective film for polarizing plate having a substrate film of a resin material and, laminated on at least one surface thereof directly or via another layer, an antireflection layer, characterized in that the substrate film has a photoelastic coefficient of less than 9×10⁻¹² Pa⁻¹ and a saturated water-absorbing percentage of less than 0.05%, and the resin material constituting the substrate film exhibits a warpage percentage of 1% or less when the film having an average thickness of 50 μm and a dimension of 100 mm×100 mm is allowed to stand at 60° C. and a humidity of 95% for 500 hours is below 1%; a method for preparing the protective film for polarizing plate; a polarizing plate with antireflection function comprising the protective film and a polarizing plate laminated thereon; and an optical article having the polarizing plate with antireflection function. The above protective film for polarizing plate has a structure which is less susceptible to warpage, deformation, and distortion even when allowed to stand in an atmosphere of high temperature and high humidity for a long period of time.

### TECHNICAL FIELD

The present invention provides a protective film for polarizing plate made from a substrate film comprising a resin and an antireflection layer laminated thereon, the resin being less susceptible to warping under high temperature and high humidity conditions and having a small photoelastic coefficient and a small water-absorbing percentage, a method for preparation thereof, a polarizing plate with antireflection function, and an optical article equipped with the polarizing plate.

### BACKGROUND ART

Conventionally, a liquid crystal display apparatus has been widely used as a displaying unit for table-top calculators, electronic watches, personal computers, word processors, and the like. Such a liquid crystal display apparatus typically has a liquid crystal cell consisting of two sheets of substrates and liquid crystals enclosed and sealed between the substrates. The liquid crystal cell has a structure in which a polarizing plate is attached to one of the surfaces and a polarizing plate with antireflection function, which is made from a polarizing plate and an antireflection layer laminated thereon, is attached to the other surface, both with an adhesive.

Such a liquid crystal display apparatus may be warped, deformed, or distorted due to expansion and contraction of the polarizing plates attached to the both sides of the liquid crystal cell according to changes in temperature and humidity, and the like. This results in deformation of the liquid crystal display apparatus into a propeller-like or other irregular configuration which affects performance of the display itself. It is difficult to fabricate a display apparatus constantly exhibiting good display performance for a long time.

The polarizing plate with antireflection function is prepared by forming an antireflection layer on a transparent synthetic resin film by PVD (physical vapor deposition) method, CVD (chemical vapor deposition) method, or the like and laminating the resulting antireflection layer-laminated resin film with a polarizing plate.

This process is carried out under vacuum. If a resin material to be formed into a film is introduced into a vacuum atmosphere, moisture contained in the film will be discharged. The moisture hinders uniform forming of an antireflection layer of the film and reduces the quality and productivity. The moisture once discharged under vacuum is absorbed again in the film when the film is released into the atmosphere after formation. The film that absorbed moisture expands. Due to the difference of the degree of expansion between the film and the laminated antireflection layer, the film deforms (curls) into a complicated shape. Curling is more conspicuous in the periphery than in the center, resulting in a shape such as a propeller, for example. When the film is laminated with another film in the subsequent step, the curling impairs processability of the film lamination. The larger the liquid crystal display screen size, the more remarkable the problem.

A common method for preventing the above-mentioned warping and deformation due to temperature and humidity change has been a mechanical control method of adhering a film with high transparency on one of the surfaces as disclosed in Japanese Patent Application Laid-open No. 8-54620, for example. However, this method required a step of adhering a film for preventing deformation. In regard to performance, the film has a problem of mechanical strength degradation such as peeling due to deformation.

The present invention has been achieved in view of the above-mentioned situation in the prior art and has an object of providing a protective film for polarizing plate having a structure less susceptible to warpage, deformation, and distortion even when allowed to stand in an atmosphere of high temperature and high humidity for a long period of time, a method for preparation of the protective film, a polarizing plate with antireflection function, and an optical article equipped with the polarizing plate.

### DISCLOSURE OF THE INVENTION

To achieve the above object, the inventors of the present invention have conducted extensive studies on the protective film for polarizing plate having an antireflection layer on at least one of the surfaces of a substrate film made of a resin material. As a result, the inventors have found that a protective film for polarizing plate with a structure less susceptible to warpage, deformation, and distortion can be obtained by using a resin material having a photoelastic coefficient and a saturated water-absorbing percentage smaller than a specific value and exhibiting only small warpage even when allowed to stand in an atmosphere of high temperature and high humidity for a long period of time. This finding has led to the completion of the present invention.

Specifically, the present invention provides a protective film for polarizing plate having a substrate film of a resin material and, laminated on at least one surface thereof directly or via another layer, an antireflection layer, characterized in that the substrate film has a photoelastic coefficient of less than 9×10⁻¹² Pa⁻¹ and a saturated water-absorbing percentage of less than 0.05%, and exhibits a warpage percentage of 1% or less when formed into a film having an average thickness of 50 μm and a dimension of 100 mm×100 mm and allowed to stand at 60° C. and a humidity of 95% for 500 hours.

In the protective film for polarizing plate of the present invention, the resin material preferably contains an alicyclic structure-containing polymer.

In the protective film for polarizing plate of the present invention, the antireflection layer is preferably a single layer film or a multilayer film with two or more layers of an inorganic oxide.

The present invention further provides a method for preparing the above protective film for polarizing plate comprising a step of forming an antireflection layer on the surface of a substrate film made of a resin material or on the surface of any layer formed on the substrate film, characterized in that the antireflection layer is formed by an ion-plating method, sputtering method, vacuum evaporation method, electroless plating method, electroplating method, or a combination of two or more of these methods.

In the method for preparing the protective film for polarizing plate of the present invention, said step of forming an antireflection layer comprises sequentially laminating two or more thin layers of inorganic oxide on the surface of a substrate film or on the surface of any layer formed on the substrate film, wherein the substrate film, with or without any other layer formed thereon, is preferably caused to pass through a series of film-forming chambers, each equipped with a means for forming a thin layer of inorganic oxide, whereby two or more thin layers of inorganic oxide are sequentially formed on the surface of the substrate film or on the surface of any layer formed on the substrate film.

In the method for preparing a protective film for polarizing plate of the present invention, the substrate film is preferably made of a resin material containing an alicyclic structure-containing polymer.

The present invention further provides a polarizing plate with antireflection function comprising the protective film for polarizing plate of the present invention and a polarizing plate, wherein the polarizing plate is laminated on one side of the substrate film on which the antireflection layer is not provided.

The present invention still further provides an optical article equipped with the above polarizing plate with antireflection function.

### BRIEF DESCRIPTION OF THE DRAWINGS

FIG. 1 is a drawing showing a method for measuring the warpage percentage of the resin material for the substrate film.

FIG. 2 is a conceptual diagram showing continuous production of the protective film for polarizing plate of the present invention using a film-forming apparatus.

FIG. 3 is a schematic diagram showing another embodiment of the apparatus for forming an antireflection layer.

FIG. 4 is a cross-sectional diagram showing the layer structure of the protective film for polarizing plate of the present invention.

FIG. 5 is a cross-sectional diagram showing the layer structure of the polarizing plate with antireflection function of the present invention.

FIG. 6 is a cross-sectional diagram showing the layer structure of the polarizing plate with antireflection function of the present invention attached to a liquid crystal display cell.

FIG. 7 is a cross-sectional diagram showing the layer structure of the liquid crystal display cell of FIG. 6.

### BEST MODE FOR CARRYING OUT THE INVENTION

The present invention will be described in detail for each item of 1) the protective film for polarizing plate, 2) the method for preparing the protective film for polarizing plate, 3) the polarizing plate with antireflection function, and 4) the optical article.

### 1) Protective Film for Polarizing Plate

The protective film for polarizing plate of the present invention comprises a substrate film of a resin material and an antireflection layer which is laminated, directly or via another layer, on at least one surface of the substrate film.

### (1) Substrate Film

The substrate film used in the present invention must satisfy the following requirements (a) to (d). Specifically, the substrate film:

(a) is made of a resin material,

(b) has a photoelastic coefficient of less than 9×10⁻¹² Pa⁻¹,

(c) has a saturated water-absorbing percentage of less than 0.05%, and

(d) exhibits a warpage percentage of 1% or less when the film having a thickness of 50 μm and a dimension of 100 mm×100 mm is allowed to stand at 60° C. and a humidity of 95% for 500 hours.

The substrate film satisfying these requirements ensures production of a protective film for polarizing plate having a structure which causes warpage, deformation, and distortion in the entire liquid crystal display only with difficulty.

(a) Resin Material

The resin contained in the resin material is not particularly limited insofar as the resin has transparency. Examples of such a resin include an alicyclic structure-containing resin, polycarbonate resin, polyester resin, polysulfone resin, polyether-sulfone resin, polystyrene resin, polyolefin resin, polyvinyl-alcohol resin, cellulose acetate resin, polyvinyl-chloride resin, polymethacrylate resin, and the like. Of these resins, the alicyclic structure-containing resin is preferable due to the small photoelastic coefficient and water-absorbing percentage.

The alicyclic structure-containing resin is a polymer having an alicyclic structure in the recurring unit and includes a polymer having the alicyclic structure in the main chain and a polymer having the alicyclic structure in the side chain.

As the alicyclic structure, a cycloalkane structure, cycloalkene structure, and the like can be given. Of these, a cycloalkane structure is preferable from the viewpoint of heat stability and the like. Although there are no specific limitations, the number of carbon atoms in the cyclic structure is usually 4-30, preferably 5-20, and still more preferably 6-15. The number of carbon atoms in the cyclic structure in this range ensures production of an oriented film with excellent heat resistance and pliability.

Although the amount of the recurring units having an alicyclic structure in the alicyclic structure-containing polymer can be appropriately determined according to the application of the product, such an amount is usually 50 wt % or more, preferably 70 wt % or more, and more preferably 90 wt % or more. If the amount of the recurring units having an alicyclic structure is too small, heat resistance decreases. Recurring units other than the recurring unit having an alicyclic structure in the alicyclic structure-containing polymer can be appropriately selected according to the application of the product.

As specific examples of the alicyclic structure-containing polymer, (i) a norbornene polymer, (ii) monocyclic cycloolefin polymer, (iii) conjugated cyclodiene polymer, (iv) vinyl alicyclic hydrocarbon polymer, hydrogenated products of the polymers (i)-(iv), and the like can be given. Of these polymers, a hydrogenated norbornene polymer, a vinyl alicyclic hydrocarbon polymer, and a hydrogenated product of the vinyl alicyclic hydrocarbon polymer are preferable due to excellent heat resistance and mechanical strength, with the hydrogenated norbornene polymer being particularly preferable.

The norbornene polymer used in the present invention is a polymer of monomers containing norbornene monomers such as norbornene and its derivatives, tetracyclododecene and its derivatives, dicyclopentadiene and its derivatives, and methanotetrahydrofluorene and its derivatives as a major component.

As specific examples of norbornene polymers, (a) a ring-opening polymer of a norbornene monomer, (b) a ring-opening copolymer of a norbornene monomer and other monomers copolymerizable with the norbornene monomer, (c) an addition polymer of a norbornene monomer, (d) an addition polymer of a norbornene monomer and other monomers copolymerizable with the norbornene monomer, hydrogenated products of the polymers (a)-(d), and the like can be given.

As examples of the norbornene monomers, bicyclo[2.2.1]hept-2-ene (trivial name: norbornene), tricyclo[4.3.0.1^{2,5}]deca-3,7-diene (trivial name: dicyclopentadiene), 7,8-benzotricyclo[4.3.0.1^{2,5}]deca-3-ene (trivial name: methanotetrahydrofluorene), and tetracyclo[4.4.0.1^{2,5}.1^{7,10}]dodeca-3-ene (trivial name: tetracyclododecene), derivatives of these compounds (for example, a compound having a substituent on the ring), and the like can be mentioned. As examples of the substituent, an alkyl group, alkylene group, alkoxycarbonyl group, carboxyl group, and the like can be given. A plurality of the same or different substituents may bond to a ring. The above norbornene monomers may be used either individually or in combination of two or more.

As examples of the monomers copolymerizable with the norbornene monomers by ring opening polymerization, monocyclic olefins such as cyclohexene, cycloheptene, and cyclooctene, and their derivatives; conjugated cyclodienes such as cyclohexadiene and cycloheptadiene, and their derivatives; and the like can be given.

The ring-opening polymers of norbornene monomers and ring-opening copolymers of norbornene monomers and the other copolymerizable monomers can be obtained by polymerizing these monomers in the presence of a ring-opening polymerization catalyst. As the ring-opening polymerization catalyst, any commonly known ring-opening polymerization catalysts can be used.

The addition polymerization polymers of norbornene monomers and addition polymerization copolymers of norbornene monomers and the other copolymerizable monomers can be obtained by polymerizing these monomers in the presence of an addition polymerization catalyst. As the addition polymerization catalyst, any commonly known addition polymerization catalysts can be used.

As examples of the monomers copolymerizable with the norbornene monomers by the addition polymerization, α-olefins having 2-20 carbon atoms such as ethylene, propylene, and their derivatives; cycloolefins such as cyclobutene, cyclopentene, and their derivatives; non-conjugated dienes such as 1,4-hexadiene; and the like can be given. These monomers may be used either individually or in combination of two or more. Of these, α-olefins are preferable, with ethylene being more preferable.

As examples of the monocyclic cycloolefin polymer, addition polymers of cyclohexene, cycloheptene, cyclooctene, and the like can be given.

As examples of the conjugated cyclodiene polymer, 1,2-addition polymers or 1,4-addition polymers of conjugated cyclodienes such as cyclopentadiene, cyclohexadiene, and the like can be given.

As examples of the vinyl alicyclic hydrocarbon polymer, polymers having a recurring unit originating from a vinyl cycloalkane or vinyl cycloalkene can be given. As examples of the vinyl alicyclic hydrocarbon polymer, polymers of a vinyl alicyclic hydrocarbon compound such as a vinyl cycloalkane (e.g. vinyl cyclohexane) or a vinyl cycloalkene (e.g. vinyl cyclohexene), or a hydrogenated product thereof; an aromatic ring-hydrogenated polymer of a vinyl aromatic hydrocarbon compound such as styrene, α-methylstyrene, or the like can be given.

The vinyl alicyclic hydrocarbon polymer may be a copolymer (random copolymer, block copolymer, etc.) of a vinyl alicyclic hydrocarbon compound or a vinyl aromatic hydrocarbon compound and other copolymerizable monomer, or a hydrogenated product of the copolymer. The block copolymers include, but are not limited to, a di-block copolymer, tri-block copolymer, greater multi-block copolymer, inclination block copolymer, and the like.

The molecular weight of the alicyclic structure-containing polymer resin, in terms of a polyisoprene-reduced or polystyrene-reduced weight average molecular weight measured by gel permeation chromatography using cyclohexane (or toluene when the polymer does not dissolve in cyclohexane) as a solvent, is usually 10,000-300,000, preferably 15,000-250,000, and more preferably 20,000-200,000. The molecular weight in this range ensures a high balance between mechanical strength and formability of the resulting film.

Hydrogenated products of the ring-opening polymer of a norbornene monomer, ring-opening copolymer of a norbornene monomer and other monomers copolymerizable with the norbornene monomer, addition polymer of a norbornene monomer, or addition polymer of a norbornene monomer and other monomers copolymerizable with the norbornene monomer can be obtained by hydrogenating the unsaturated C—C bonds of these polymers using a known hydrogenation catalyst to a hydrogenation degree preferably of 90% or more.

Although the glass transition temperature of the resin material can be appropriately selected according to the object of use, the glass transition temperature is preferably 80° C. or more, and more preferably 100-250° C. The resin material with a glass transition temperature in this range can produce a substrate film exhibiting excellent durability without deformation or stress during use under high temperature and high humidity.

Although not specifically limited, the molecular weight distribution, in terms of the weight average molecular weight (Mw)/the number average molecular weight (Mn), of the resin material is usually 1.0-10.0, preferably 1.0-6.0, and more preferably 1.1-4.0. The molecular weight distribution in this range ensures a good balance between the mechanical strength and formability of the resulting film.

A film formed to have an average thickness of 50 μm and a dimension of 100 mm×100 mm, exhibiting a warpage percentage of 1% or less when allowed to stand at 60° C. and a humidity of 95% for 500 hours, is used as the substrate film in the present invention. The substrate film formed into a prescribed shape and exhibiting a small warpage percentage of 1% or less when allowed to stand under high temperature and high humidity conditions for a long time ensures excellent adhesion with an antireflection layer and superior processability when applied to other films.

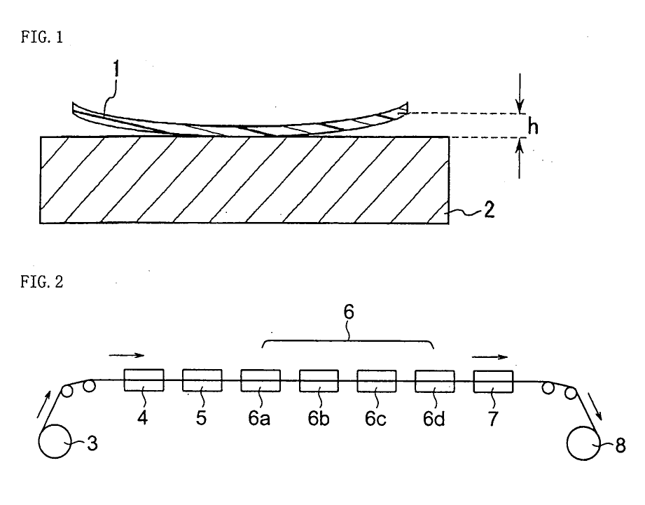

The warpage percentage can be determined as follows. A film 1 with an average thickness of 50 μm and a dimension of 100 mm×100 mm is formed from the same resin material as that used in the substrate film. The film 1 is allowed to stand for 500 hours under the conditions of 60° C. and 95% RH. Then, the formed film 1 after the test is placed on a horizontal table 2 as shown in FIG. 1 to measure the distance h (mm) between the table and the lowest point of the film using a caliper. The ratio (%) of the measured distance in the length of the film (100 mm) is determined as the warpage percentage. Specifically, the warpage percentage (%) is determined using the formula: warpage percentage (%)=(h/100)×100. When allowed to stand for 500 hours under the atmosphere at a temperature of 60° C. and a humidity of 95%, the formed film 1 deforms either convexly or concavely. In either case, the film after the test is placed on horizontal table 2 as shown in FIG. 1 to measure the warpage (h).

Various additives can be added to the resin material if desired. Any additives that can be commonly used in thermoplastic resin materials may be used without any specific limitation. Given as examples are antioxidants such as a phenolic antioxidant, phosphoric acid antioxidant, and sulfuric acid antioxidant; UV absorbers such as a benzotriazole UV absorber, benzoate UV absorber, benzophenone UV absorber, acrylate UV absorber, and metal-complex UV absorber; lightstabilizers such as a hindered amine lightstabilizer; coloring agents such as a dye and pigment; lubricantses such as an ester of aliphatic alcohol, ester of polyhydric alcohol, fatty-acid amide, and inorganic particles; plasticizers such as a triester plasticizer, phthalate plasticizer, fatty acid-basic acid ester plasticizer, and oxy acid ester plasticizer; antistatic agents such as a fatty acid ester of polyhydric alcohol; and the like.

The melt flow rate of the resin material used in the present invention, determined at 280° C. at a load (%) of 2.16 kgf, is usually 1-100 g/10 minutes, preferably 2-50 g/10 minutes, and more preferably 3-40 g/10 minutes. If the melt flow rate is smaller than 1 g/10 minutes, formability is poor; if greater than 100 g/10 minutes, a sheet formed from the resin material may have an uneven thickness.

(b) Photoelastic Coefficient

The substrate film used in the present invention has a photoelastic coefficient of less than 9×10⁻¹² Pa⁻¹, and preferably less than 7×10⁻¹² Pa⁻¹. The small photoelastic coefficient of less than 9×10⁻¹² Pa⁻¹ of the substrate film used in the present invention prevents optical distortion by an external stress and phase difference by a minute stress change.

The photoelastic coefficient is also referred to as a piezo optical coefficient, which is a constant value of a substance indicating the magnitude of the piezo optical effect (photoelasticity effect) of the substance, and can be measured using an ellipsometer. The photoelastic coefficient is a value indicating the degree of the optical distortion to an external stress. The smaller the value, the optically better the material is as a protection film of a polarizing plate.

(c) Saturated Water-absorbing Percentage

The substrate film used in the present invention has a saturated water-absorbing percentage of less than 0.05 wt %, and preferably less than 0.03 wt %. A small saturated water-absorbing percentage of less than 0.05 wt % of the substrate film used in the present invention prevents a decrease in the substrate film quality due to discharge of water during formation of an antireflection layer and also prevents a decrease in the productivity. The small saturated water-absorbing percentage also prevents an antireflection layer from peeling from the substrate film on account of expansion or contraction due to moisture absorption during prolonged use.

The saturated water-absorbing percentage of the substrate film can be determined according to ASTM D530 by measuring a weight increase after one week of dipping at 23° C.

(d) Content of Volatile Components

The substrate film used in the present invention has a volatile component content of preferably 0.1 wt % or less, and more preferably 0.05 wt % or less. The content of volatile components in the above range improves dimensional stability of the substrate film and prevents uneven lamination when a hard-coat layer is laminated. Formation of a homogeneous antireflection layer over the entire film surface ensures a uniform reflective prevention effect all over the film.

The volatile components are substances with a molecular weight of 200 or less contained in a slight amount in the substrate film such as, for example, remaining monomers, solvents, and the like. The content of volatile components can be determined by gas chromatography analysis of the substrate film as the total amount of substances having a molecular weight of 200 or less in the alicyclic structure-containing polymer.

The substrate film used in the present invention can be obtained by forming the above resin material by a known method and adjusting the photoelastic coefficient, saturated water-absorbing percentage, and volatile component content.

As the method for forming the resin material into a film, a solution casting method or a melt extrusion molding method can be given. The melt extrusion molding method is more preferable to decrease the content of volatile components and obtain a substrate film with uniform thickness. As the melt extrusion molding method, a method of using a die such as a T-die, an inflation method, and the like can be given. The method of using a T-die is preferable because of high productivity and excellent thickness precision.

When the T-die method is used for forming a substrate film, the temperature for melting the resin material in the extruder having a T-die is preferably 80-180° C. higher, and more preferably 100-150° C. higher than the glass transition temperature of the resin material. When the temperature of the extruder is too low, the flowability of the resin material may be insufficient. If the temperature is too high, on the other hand, the resin material may degrade. It is desirable to preliminarily dry the resin material before producing films. For preliminary drying, the raw material is pelletized, for example, and the pellets are dried in a hot air dryer. A drying temperature of 100° C. or higher and a drying time of two hours or more are preferable. The preliminary drying can reduce the amount of volatile components in the film and prevent forming of the resin material when extruded.

A preferred embodiment of the method for preparing the substrate film used in the present invention has a step of cooling the molten resin material extruded from the extruder in a series of externally installed cooling drums comprising a first cooling drum, a second cooling drum, and a third cooling drum, in which the resin material is cooled in this order, and a step of delivering the molten resin material extruded from the extruder to the first cooling drum, second cooling drum, and third cooling drum in this order, wherein the ratio of the circumferential speed R₃ of the third cooling drum to the circumferential speed R₂ of the second cooling drum (R₃/R₂) is less than 0.999 but 0.990 or more. If the ratio R₃/R₂ is too large, the resin material is oriented giving rise to a tendency of warpage and uneven thickness in the resulting substrate film. If the ratio R₃/R₂ is too small, on the other hand, the resin material is loosened, droops down, and is oriented due to its weight acting as a tension, also giving rise to a tendency of warpage and uneven thickness in the resulting substrate film. The ratio R₃/R₂ of the circumferential speeds in the above range prevents the molten resin material from being loosened and ensures preparation of a substrate film with only slight warpage and uneven thickness, while the resin material is drawn at appropriate tension.

In addition, the ratio of the circumferential speed R₂ of the second cooling drum to the circumferential speed R₁ of the first cooling drum (R₂/R₁) is preferably less than 1.01 but 0.990 or more, and more preferably less than 1.000 but 0.995 or more. The ratio R₂/R₁ in this range ensures particularly small molecular orientation, which results in production of a film with a small heat contraction rate. The ratio R₂/R₁ of the above range also prevents whirled wrinkles.

In this instance, the temperature difference of the first and second cooling drums is preferably is 20° C. or less. The residual stress in the film can be suppressed by cooling the resin material while retaining the temperature difference of the two cooling drums within 20° C.

A substrate film of which either or both surfaces are reformed may be used in the present invention. The surface reforming treatment can improve adhesion with a hard-coat layer. As the surface reforming process, irradiation with energy rays, treatment with chemicals, and the like can be given.

As the method for energy ray irradiation, a corona discharge treatment, plasma treatment, electron beam irradiation treatment, ultraviolet irradiation treatment, and the like can be mentioned. A corona discharge treatment and plasma treatment, particularly corona discharge treatment, are preferable due to excellent treatment efficiency and the like.

For chemical treatment, the substrate film is dipped in an aqueous solution of an oxidizing agent such as a potassium dichromate solution or concentrated sulfuric acid, and thoroughly washed with water. Although shaking while dipping is efficient, the resin material on the surface may be dissolved or transparency of the substrate film may be impaired when the substrate film is treated for a long time. Therefore, the treatment time should be adjusted according to the reactivity and concentration of the chemicals used.

The thickness of the substrate film is preferably 30-300 μm, and more preferably 40-200 μm from the viewpoint of mechanical strength and the like.

### (2) Antireflection Layer

The protective film for polarizing plate of the present invention has an antireflection layer laminated directly or via another layer on the above-described substrate film.

The antireflection layer is an area in charge of a substantial reflection preventive function and may have a single layer structure or a multilayer structure as appropriate. For example, structures described in “Optics of Thin Films”, pp 159-283 (A. Vasicek, North Holland Publishing Company, Amsterdam (1960)), Japanese Patent Applications Laid-open No. 1982-46301, No. 1984-49501, No. 1984-50401, or No. 1989-294709, Japanese Patent Publication No. 1994-5324, etc. can be given.

The structure of the antireflection layer of the present invention is preferably a single layer film or a multilayer film with two or more layers of an inorganic oxide, more preferably a complex multilayer film (having two or more layers) of two types of alternately laminated layers, one being a thin film made from an inorganic oxide with a comparatively low refractive index and the other being a thin film made from another inorganic oxide with a comparatively high refractive index. The thickness, refractive index, and the like of each layer in such a complex multilayer film can be determined according to known technologies described in Optics of Thin Films, A. Vasicek, and the like.

Inorganic materials can be used for forming the antireflection layers. As specific examples, inorganic oxides such as SiO₂, Al₂O₃, ZrO₂, TiO₂, Ta₂O₅, TaHf₂, SiO, TiO, Ti₂O₃, HfO₂, ZnO, In₂O₃/SnO₂, Y₂O₃, Yb₂O₃, Sb₂O₃, MgO, and CeO₂; inorganic fluorides such as LiF, NaF, MgF₂, 3NaF/AlF₃, BaF₂, CaF₂, SrF₂, LaF₂, AlF₃, and Na₃AlF₆; and the like can be given.

Instead of using a material with a known refractive index, it is possible to use a material containing ultra-fine particles dispersed in a matrix such as a resin, of which the refractive index is variable and adjustable to the target refractive index. As candidates of the fine particles to be dispersed in the matrix, fine particles of inorganic fluoride such as magnesium fluoride, fine particles of silica, minute vacuum hollow particles, and minute hollow particles of gas such as air, nitrogen, or the like can be given. From the viewpoint of obtaining a low refractive index material, a material in which hollow fine particles of silica are dispersed in a matrix is preferable. As the method for forming the layers containing these fine particles, a method of obtaining a coating composition by dispersing fine particles in a matrix and coating and drying the composition can be given.

The thickness of the antireflection layer is usually 0.01-50 μm, preferably 0.1-30 μm, and still more preferably 0.5-20 μm. If the thickness is less than 0.01 μm, an antireflection effect cannot be demonstrated; if more than 50 μm, the thickness tends to be uneven, resulting in an impaired external appearance.

### (3) Other Layers

The protective film for polarizing plate of the present invention may contain an additional layer or layers between the substrate film and the antireflection layer. As examples of such additional layers, a primer layer and a hard-coat layer can be given.

The primer layer is formed to provide and increase the adhesiveness of the substrate film with the antireflection layer. As the material to form the primer layer, polymers such as a polyester polyurethane resin, polyether polyurethane resin, polyisocyanate resin, polyolefin resin, resin having a hydrocarbon skeleton and/or a polybutadiene skeleton in the main chain, polyamide resin, acryl resin, polyester resin, vinyl chloride-vinyl acetate copolymer, chlorinated rubber, and cyclized rubber, as well as resins or rubbers modified by introducing polar groups into these polymers can be given.

Of these, modified resins of the resin having a hydrocarbon skeleton and/or a polybutadiene skeleton in the main chain or the cyclized rubber are preferable.

As the resin having a hydrocarbon skeleton and/or a polybutadiene skeleton in the main chain, a resin having a polybutadiene skeleton or a skeleton with at least a part thereof being hydrogenated, for example, a polybutadiene resin, hydrogenated polybutadiene resin, styrene-butadiene-styrene block copolymer (SBS copolymer), hydrogenated SBS copolymer (SEBS copolymer), and the like can be given. Of these resins, a modified product of hydrogenated styrene-butadiene-styrene block copolymer is particularly preferable.

As the polar group to be introduced, carboxylic acid and derivatives of carboxylic acid are preferable. As specific examples, modified products of an unsaturated carboxylic acid such as acrylic acid, methacrylic acid, maleic acid, and fumaric acid; derivatives of halides, amides, imides, anhydrides, esters, etc. of an unsaturated carboxylic acid, such as maleyl chloride, maleimide, maleic anhydride, and citraconic anhydride; and the like can be given. Of these, a modified product of an unsaturated carboxylic acid or a modified product of an unsaturated carboxylic anhydride is preferable due to excellent adhesion, with acrylic acid, methacrylic acid, maleic acid, and maleic anhydride being more preferable, and maleic acid and maleic anhydride being particularly preferable. These unsaturated carboxylic acids and the like may be used either individually or in combination of two or more.

There are no specific limitations to the method for forming the primer layer. For example, a method of forming a primer layer by coating the substrate film with a coating solution for primer layer using a known coating means can be given.

The thickness of the primer layer is usually 0.01-5 μm, and preferably 0.1-2 μm.

A hard-coat is formed to reinforce the surface hardness, anti-fatigue properties during repeated use, and scratch resistance of the substrate film. As the material for forming the hard-coat layer, organic hard-coat materials such as an organic silicone hard-coat material, melamine hard-coat material, epoxy hard-coat material, and acrylic hard-coat material; inorganic hard-coat materials such as silicon dioxide; and the like can be given. Of these, a polyfunctional acrylate hard-coat material is preferable from the viewpoint of excellent adhesiveness and superior productivity. There are no specific limitations to the method for forming the hard-coat layer. For example, a method of coating a substrate film with a solution of a hard-coat layer material using a known coating means and curing the coating by irradiation of UV rays can be given. Although there are no specific limitations, the thickness of the hard-coat layer is usually 0.5-30 μm, and preferably 3-15 μm.

In the protective film for polarizing plate of the present invention, an antifouling layer is preferably provided on the antireflection layer to protect the antireflection layer and increase antifouling properties.

There are no specific limitations to the materials for the antifouling layer insofar as the required performance for the antifouling layer is satisfied without hindering the functions of the antireflection layer. Usually, a compound having a hydrophobic group can be used. As specific examples, a perfluoroalkyl silane compound, perfluoro polyether silane compound, and a fluorine-containing silicone compound can be given. As the method for forming the antifouling layer, a physical vapor growth method such as vapor deposition and sputtering, a chemical vapor growth method such as CVD, a wet coating method, and the like can be used according to the material used. Although there are no specific limitations, the thickness of the antifouling layer is usually 20 nm or less, and preferably 1-10 nm.

Since the protective film of the present invention excels in gas barrier properties, the film can prevent steam and oxygen from penetrating and degrading performance of the polarizing plate when it is attached to a polarizing plate. The gas barrier properties can be evaluated by the oxygen gas permeability and steam permeability. The protective film for polarizing plate of the present invention preferably has oxygen gas permeability of 2.5 cm³/m²/day/atm or less at 23° C. and 90% RH, and steam permeability of 2.5 g/m²/day/atm or less at 38° C. and 100% RH. More preferably, the oxygen gas permeability is 2.0 cm³/m²/day/atm or less and steam permeability is 2.0 g/m²/day/atm or less. The oxygen gas permeability and steam permeability can be measured using a known oxygen gas permeability measurement system and steam permeability measurement system.

The protective film for polarizing plate of the present invention is useful for various liquid crystal display elements, electroluminescence display elements, and touch panels for a cellular phone, digital information terminal, pocket pager (registered trademark), navigation, in-vehicle liquid crystal display, liquid crystal display monitor, light-adjusting panel, display for OA equipment, and display for AV equipment, and the like.

### 2) Method for Preparing Protective Film for Polarizing Plate

The method for preparing protective film for polarizing plate of the present invention comprises a step of forming an antireflection layer on the surface of substrate film of a resin material or on the surface of any other layer formed on the substrate film, wherein the antireflection layer is formed by an ion plating method, sputtering method, vacuum evaporation method, electroless plating method, or electroplating method or by any combination of these methods.

In the method for preparing protective film for polarizing plate of the present invention, the step of forming an antireflection layer comprises sequentially laminating two or more thin layers of inorganic oxide on the surface of the substrate film or on the surface of any other layer formed on the substrate film, wherein the substrate film, either with or without any other layer formed thereon, is preferably caused to pass through two or more film-forming chambers having a film-forming means to form thin layers of inorganic oxide, whereby two or more thin layers of inorganic oxide are sequentially laminated on the surface of the substrate film or on the surface of any other layer formed on the substrate film by a film-forming means installed in each film-forming chamber.

The substrate film used in the method for preparing a protective film for polarizing plate of the present invention has a photoelastic coefficient of less than 9×10⁻¹² Pa⁻¹ and a saturated water-absorbing percentage of less than 0.05%, and exhibits a warpage percentage of 1% or less when formed into a film having an average thickness of 50 μm and a dimension of 100 mm×100 mm and allowed to stand at 60° C. and a humidity of 95% for 500 hours. A drying step prior to the step of forming an antireflection layer, which has been essential in conventional methods, need not be provided in the method of the present invention. In addition, the film before forming an antireflection layer need not be preserved or delivered under special dry conditions to prevent moisture absorption. Therefore, a protective film for polarizing plate can be continuously produced by continuously forming a primer layer, hard-coat layer, antireflection layer, and antifouling layer on the substrate film.

This method of continuous production can be carried out using a film-forming apparatus shown in FIG. 2. The film-forming apparatus shown in FIG. 2 consists of a primer layer forming section 4, hard-coat layer forming section 5, antireflection layer forming section 6, and antifouling layer forming section 7. The antireflection layer-forming section 6 comprises four film-forming chambers (6a-6d), each provided with a means for forming a thin layer of inorganic oxide. This film-forming apparatus is a continuous apparatus for continuously forming a primer layer, a hard-coat layer, four antireflection layers, and an antifouling layer on the substrate film.

First, in the primer layer forming section 4 and the hard-coat layer forming section 5, a primer layer and a hard-coat layer are sequentially formed on a lengthwise substrate film 3 reeled out from a roller. The primer layer and hard-coat layer are formed using the materials and methods mentioned above.

Next, the substrate film is caused to pass sequentially through four film-forming chambers (6a-6d) of the antireflection-layer forming section 6, in which thin films are sequentially laminated on the surface of the hard-coat layer of the substrate film by the film forming means in each of the film-forming chambers, whereby the antireflection layer consisting of four layers can be obtained. There are no specific limitations to the method for forming the antireflection layer. Any one of known methods such as an ion-plating method, sputtering method, vacuum evaporation method, electroless plating method, and electroplating method can be used for forming a thin layer of inorganic oxide.

The substrate film on which the antireflection layer was formed is then sent to the antifouling layer forming section 7, wherein an antifouling layer is formed on the antireflection layer. The antifouling layer is formed using the materials and methods mentioned above. The substrate film on which the antifouling layer has been formed (a protective film for polarizing plate) 8 can be rolled up, stored, and transported.

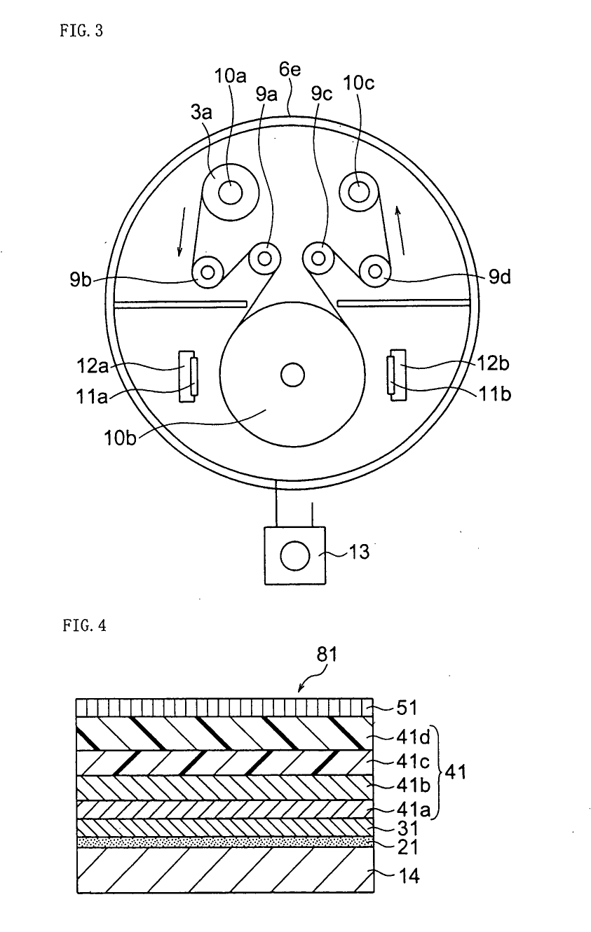

An apparatus shown in FIG. 3 can be given as another embodiment of the apparatus for forming the antireflection layer. The continuous vacuum sputtering film-forming apparatus shown in FIG. 3 has a vacuum chamber 6e provided with a roll-out reel 10a, guide rollers 9a, 9b, 9c, and 9d, film-forming roller 10b, film-forming cathodes 12a and 12b equipped with targets 11a and 11b, a roll-on reel 10c, and a vacuum pump 13. A lengthwise film 3a a hard-coat layer laminated thereon is rolled on the roll-out reel 10a.

Although the continuous vacuum sputtering film-forming apparatus shown in FIG. 3 is equipped with two targets and two film-forming cathodes, the number of the target and film-forming cathode is not specifically limited.

The rolled-up substrate film 3a on which the hard-coat layer has been laminated is reeled out from the roll-out reel 10a, guided by guide rollers 9a and 9b, caused to come in contact with the film-forming roller 10b, guided by other guide rollers 9c and 9d, and rolled-up around the roll-on reel 10c. Film forming cathodes 12a and 12b equipped with targets 11a and 11b are installed around the film-forming roller 10b to continuously form a low refractive index layer and a high refractive index layer by sputtering on the surface of the substrate film 3a wound around the film-forming roller 10b. The substrate film 3a on which a hard-coat layer, with a low refractive index layer and a high refractive index layer being laminated thereon, is guided by guide rollers 9c and 9d on the opposite side and rolled up by the roll-on reel 10c.

The temperature Ts(° C.) of the film-forming roller 10b in preferably satisfying an unequality, (Tg−130)(° C.)<Ts(° C.)<Tg(° C.), wherein Tg is a glass transition temperature of the resin material used for the substrate film. The temperature Ts(° C.) of the film-forming roller in the above range ensures uniform lamination of a high refractive index layer and low refractive index layer over the entire surface of the substrate film a hard-coat layer laminated thereon.

All through the film-forming process by sputtering, the vacuum chamber 6e is evacuated by a vacuum pump 13 and a carrier gas and reactive gas necessary for film-forming are introduced via a cylinder, which is not shown in the drawing. An inert gas can be given as the effect gas. Specifically, a rare gas such as argon is used. Oxygen is the most common reactive gas. The pressure in the vacuum chamber is usually in the range of 10⁻²-10⁻⁵ Pa.

When forming two or more low refractive index layers and high refractive index layers in the present invention, the low refractive index layers and high refractive index layers may be continuously formed by alternately changing the direction of winding and the like using a film roll-up type vacuum film-forming apparatus as shown in FIG. 3 (for example, the roll-up reel 10c may be used as a roll-out reel and the roll-out reel 10a is used as a roll-up reel), or two film roll-up type vacuum film-forming apparatuses shown in FIG. 3 may be installed in series to continuously form low refractive index layers and high refractive index layers.

Although the total four antireflection layers are continuously formed for preparing the protective film for polarizing plate in this embodiment, the number of antireflection layers is not necessarily limited to four. A single antireflection layer or two, three, five or more antireflection layers can be formed in the same manner.

When continuously forming two or more antireflection layers or when forming an antifouling layer on the antireflection layer, a surface reforming treatment can be effected on the surface of an antireflection layer to increase adhesion of the antireflection layer with the other antireflection layer or the antifouling layer. The surface reforming treatment can improve adhesion of an antireflection layer with another antireflection layer or an antifouling layer. As the surface reforming process, irradiation with energy rays and treatment with chemicals, which are mentioned above, can be given.

An example of the layer configuration of the protective film for polarizing plate prepared in this manner is shown in FIG. 4. The protective film for polarizing plate 81 shown in FIG. 4 consists of a substrate film layer 14, a primer layer 21, a hard-coat layer 31, an antireflection layer 41, which consists of a first antireflection film 41a, second antireflection film 41b, third antireflection film 41c, and fourth antireflection film 41d, and the antifouling layer 51, laminated from the bottom to the top.

The protective film for polarizing plate prepared by the method of the present invention exhibits excellent interlaminer adhesion and does not cause interlaminer delamination even if placed under high temperature and high humidity conditions for a long time.

### 3) Polarizing Plate with Antireflection Function

The polarizing plate with antireflection function of the present invention has a polarizing plate laminated on one side of the substrate film of the protective film for polarizing plate of the present invention on which the antireflection layer is not provided.

There are no specific limitations to the polarizing plate used in the present invention insofar as the polarizing plate has the function of a polarizer. Polyvinyl alcohol (PVA)-based polarizing plates and polyene-based polarizing plates can be given, for example.

There are no specific limitations to the method of manufacturing the polarizing plate. As the method for preparing a PVA-based polarizing plate, a method of uniaxially drawing a PVA film after iodine ion adsorption, a method of adsorbing iodine ion after uniaxially drawing a PVA film, a method of uniaxially drawing a PVA film while the PVA film is adsorbing iodine ion, a method of uniaxially drawing a PVA film after dyeing the PVA film with a dichroic dye, a method of dyeing the PVA film with a dichroic dye after uniaxially drawing the PVA film, and a method of uniaxially drawing a PVA film while dyeing the PVA film with a dichroic dye can be given. As the method for preparing a polyene-based polarizing plate, known methods such as a method of heating and dehydrating a PVA film in the presence of a dehydration catalyst after uniaxially drawing the PVA film, a method of heating and dehydrating a polyvinyl chloride film in the presence of a dehydration catalyst after uniaxially drawing the film, and the like can be given.

The polarizing plate with antireflection function of the present invention has a polarizing plate laminated on the one side of the substrate film of the protective film for polarizing plate of the present invention on which the antireflection layer is not provided.

The protective film for polarizing plate is laminated with the polarizing plate by appropriate means using an adhesive, an agglutinant, or the like. As examples of the adhesive or agglutinant, acrylic, silicone-based, polyester-based, polyurethane-based, polyether-based, or rubber-based adhesives and agglutinants can be given. Of these, acrylic adhesives and agglutinants are preferable in view of heat resistance, transparency, and the like.

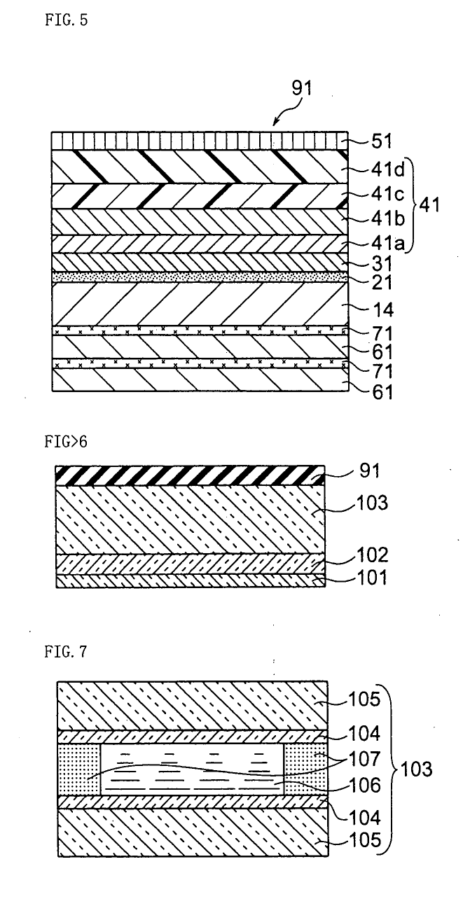

A cross-sectional diagram showing the layer structure of the polarizing plate with antireflection function of the present invention is shown in FIG. 5. The polarizing plate with antireflection function 91 shown in FIG. 5 has a structure in which a polarizing plate 61 is laminated via an adhesive or agglutinant layer 71 on the side of the protective film for polarizing plate of the present invention on which the antireflection layer 41 is not provided.

In the polarizing plate with antireflection function of the present invention, another protective film may be provided via an adhesive or agglutinant layer on the side of the polarizing plate on which the protective film of the present invention is not provided. A material with a small optical anisotropy is preferably used as the protective film. There are no specific limitations to the material with a small optical anisotropy. As examples, cellulose esters such as triacetyl cellulose, an alicyclic structure-containing polymer, and the like can be given. An alicyclic structure-containing polymer is preferable due to excellent transparency, low birefringence, dimensional stability, and the like. As examples of the alicyclic structure-containing polymer, polymers mentioned in the description of the substrate film of the present invention can be given. As examples of the adhesive or agglutinant, the same adhesives and agglutinants used for laminating the protective film for polarizing plate with the polarizing plate can be given. Although there are no specific limitations to the thickness of the polarizing plate with antireflection function, the thickness is usually from 60 μm to 2 mm.

The polarizing plate with antireflection function of the present invention has a structure which causes warpage, deformation, and distortion only with difficulty even if placed in an environment of high temperature and high humidity for a long time.

### 4) Optical Article

The optical article of the present invention has the polarizing plate with antireflection function of the present invention. As preferable specific examples of the optical article of the present invention, a liquid crystal display, touch panel, electroluminescence display, and the like can be given.

As an example of the optical article equipped with the polarizing plate with antireflection function of the present invention, a layer configuration of a liquid crystal display equipped with the polarizing plate with antireflection function of the present invention is shown in FIG. 6. The liquid crystal display apparatus shown in FIG. 6 consists of a polarizing plate 101, a wave plate 102, a liquid crystal cell 103, and a polarizing plate with antireflection function 91 of the present invention, laminated from the bottom to the top. The polarizing plate with antireflection function 91 is formed on the liquid crystal cell 103 via an adhesive or agglutinant (not shown), with the liquid crystal cell 103 being attached to the side of the polarizing plate. As shown in FIG. 7, the liquid crystal cell 103 is prepared by placing two sheets of electrode substrates 105, each equipped with a transparent electrode 104, facing vis-a-vis with a prescribed space between them and filling liquid crystal 106 in the space. In FIG. 7, 107 indicate a sealing material.

There are no specific limitations to liquid-crystal mode of the liquid crystal 106. As the liquid-crystal mode, TN (twisted nematic) type, STN (super twisted nematic) type, HAN (hybrid alignment nematic) type, VA (vertical alignment) type, MVA (multiple vertical alignment) type, IPS (in-plane switching) type, OCB (optical compensated bend) type, and the like can be given.

The liquid crystal display of FIG. 7 can be used either in the normal white mode in which the display is bright when the applied voltage is low and dark when the applied voltage is high or in the normal black mode in which the display is dark when the applied voltage is low and bright when the applied voltage is high.

The optical article of the present invention is equipped with the polarizing plate with antireflection function of the present invention which exhibits excellent durability without deformation or stress during use under high temperature and high humidity conditions. Therefore, the optical article is free from discoloration at the end of the display panel and color variation in the display panel.

### EXAMPLES

The present invention will be described in more detail by way of examples. The present invention, however, should not be limited to these examples.

### (1) Molecular Weight and Molecular Weight Distribution

Measured by gel permeation chromatography (GPC) and calculated as a polyisoprene reduced value.

### (2) Glass Transition Temperature (Tg)

Measured according to JIS K7121.

### (3) Melt Flow Rate

Measured according to JIS K6719 at 280° C. under a load of 2.16 kgf.

### Preparation Example 1

A mixture containing 7,8-benzotricyclo[4.3.0.1^{2,5}]deca-3-ene (trivial name: methanotetrahydrofluorene, hereinafter abbreviated to as MTF), tetracyclo[4.4.0.1^{2,5}.1^{7,10}]-dodeca-3-ene (trivial name: tetracyclododecene, hereinafter abbreviated to as TCD), and tricyclo[4.3.0.1^{2,5}]deca-3,7-diene (trivial name: dicyclopentadiene, hereinafter abbreviated to as DCP) at a weigh ratio of MTF/TCD/DCP=26.8/35/38.2 was polymerized by a known method of ring-opening polymerization. The resulting polymer was hydrogenated to obtain hydrogenated ring-opening copolymer 1 of MTF, TCD, and DCP. The weight average molecular weight (Mw) of the hydrogenated ring-opening copolymer 1 was 41,000, MWD (=weight average molecular weight/number average molecular weight) was 2.1, the glass transition temperature (Tg) was 136° C., and the melt flow rate was 4.2 g/10 minutes.

0.2 part by weight of a phenol-based aging preventive, pentaerythrityltetrakis(3-(3,5-di-tert-butyl-4-hydroxyphenyl)propionate) was added to and mixed with 100 parts by weight of the hydrogenated ring-opening copolymer 1. The mixture was kneaded in a biaxial kneader to obtain fused resin rods. The resin rods were cut into pellets (particles) using a strand cutter to obtain a forming material.

### Preparation Example 2

A mixture of DCP and bicyclo[4.2.1]hept-2-ene (trivial name: norbornene, hereinafter abbreviated to as NB) at a weight ratio of DCP/NB=80/20 was polymerized by a known method of ring-opening polymerization. The resulting polymer was hydrogenated to obtain hydrogenated ring-opening copolymer 2 of DCP and NB. Mw of the hydrogenated ring-opening copolymer 2 was 43,000, MWD was 3.2, Tg was 70° C., and the melt flow rate was 23 g/10 minutes. A forming material in the form of pellets (particles) was prepared from the hydrogenated ring-opening copolymer 2 in the same manner as in Preparation Example 1.

### Preparation Example 3

### Preparation of Hard-coat Agent

30 parts by weight of hexa-functional urethane acrylate oligomer (“NK oligo U-6HA” manufactured by Sin-Nakamura Chemcal Co., Ltd.), 40 parts by weight of butyl acrylates, 30 parts by weight of isobornyl methacrylate (“NK ester IB” manufactured by Sin-Nakamura Chemcal Co., Ltd.), and 10 parts by weight of 2,2-dimethoxy-1,2-diphenylethan-1-on were mixed in a homogenizer to prepare a hard-coat agent.

### Preparation Example 4

### Preparation of Primer Solution

2 parts by weight of hydrogenated block copolymer of maleic anhydride-modified styrene, butadiene, and styrene (“Toughtech M1913” manufactured by Asahi Kasei Corporation; melt-index: 4.0 g/10 minutes at 200° C. and 5 kg load, styrene block content: 30 wt %, hydrogenation rate: 80% or more, amount of maleic anhydride added: 2%) was dissolved in a mixed solution of 8 parts by weight of xylene and 40 parts by weight of methyl isobutyl ketone. The mixture was filtered through a polytetrafluoroethylene filter with a pore diameter of 1 μm to obtain a complete solution to be used as a primer solution.

### Example 1

The pellets obtained in Preparation Example 1 were dried at 110° C. for four hours using a hot air dryer in which air is circulated. The dry pellets were extruded at a molten resin temperature of 260° C. and a die temperature of 260° C. from a T-die type molten film extruder equipped with a leaf disk-type polymer filter (filtration accuracy: 30 μm) and a molten resin kneader with a 65 mmØ screw, using a T-die with a width of 350 mm, with an internal surface plated with chromium to provide a surface roughness of Ra=0.15 μm. The extruded sheet of hydrogenated MTF/TCD/DCP ring-opening copolymer 1 was transmitted by causing the sheet to adhere sequentially to a first cooling drum (diameter: 250 mm, temperature: 135° C., and circumferential speed R₁: 14.50 m/min), a second cooling drum (diameter: 250 mm, temperature: 125° C., and circumferential speed R₂: 14.46 m/min), and a third cooling drum (diameter: 250 mm, temperature: 100° C., and circumferential speed R₃: 14.46 m/min) to obtain a substrate film 1A with a length of 300 mm and a thicknesses of 40 μm. The obtained lengthwise substrate film 1A was rolled-up on a reel. The content of volatile components of the substrate film 1A was 0.01 wt % or less and the saturated water-absorbing percentage was 0.01 wt % or less.

Both sides of the substrate film 1A were treated with corona discharge for 3 seconds using a high frequency oscillator (corona generator “HV05-2” manufactured by Tamtec Co., Ltd.) under the conditions of output voltage of 100% and output of 250 W, using a wire electrode with a diameter of 1.2 mm, electrode length of 240 mm, and a work electrode distance of 1.5 mm, to obtain a surface reformed substrate film 1B with a surface tension of 0.072 N/m. The obtained film was again rolled-up on a reel.

The primer solution obtained in Preparation Example 4 was applied to one of the sides of the reformed surface of the substrate film 1B using a die coater to produce a primer layer with a thickness of 0.5 μm after curing. The coating was dried for 5 minutes in a drier at 80° C. to obtain a substrate film 1C having a primer layer.

The hard-coat agent obtained in Preparation Example 3 was continuously applied to the primer layer side of the substrate film 1C using a die coater to produce a hard-coat layer with a thickness of 5 μm after drying. After drying for 5 minutes at 80° C., the coating was irradiated with UV rays (accumulated amount of luminous energy: 300 mJ/cm²) to cure the hard-coating agent, thereby obtaining a film 1D with a hard-coat layer. The obtained film 1D with a hard-coat layer was rolled-up on a reel. The thickness of the cured hard-coat layer after curing was 5 μm.

The reel with the roll-up lengthwise film 1D with a hard-coat layer was installed in a continuous vacuum sputtering film-forming apparatus shown in FIG. 3. The internal atmosphere of the apparatus was evacuated. When the pressure in the chamber was reduced to 1×10⁻⁵ Pa, sputtering onto the film-forming roller was initiated at 80° C. to form an antireflection layer consisting of four layers of alternately laminated low refractive index layers (SiO₂ layers) and high refractive index layers (ITO layers). The antireflection layer consisted of a first SiO₂ layer with a thickness of 20 nm, a first ITO layer with a thickness of 30 nm, a second SiO₂ layer with a thickness of 40 nm, and a second ITO layer with a thickness of 100 nm.

Next, as an antifouling layer, a fluorine-containing surface antifouling refractory coating (“Optool DSX” manufactured by the Daikin Industries, LTD.) diluted with perfluorohexane to a concentration of 0.1 wt % was applied to the surface of the antireflection layer by dip coating method. The applied material was dried with heating at 60° C. for one minute to form an antifouling layer.

A protective film for polarizing plate 1E having the same layer structure as that shown in FIG. 4 was obtained.

### Comparative Example 1

A protective film for polarizing plate 2E of Comparative Example 1 was prepared in the same manner as in Example 1, except that a triacetylcellulose film with a thickness of 50 μm (“Fujitack” manufactured by Fuji Photo Film Co., Ltd., herein indicated as “substrate film 2A”) was used instead of substrate film 1A.

### Comparative Example 2

A protective film for polarizing plate 3E of Comparative Example 2 was prepared in the same manner as in Example 1, except that a polyethyleneterephthalate film with a thickness of 50 μm (“Lumirror T60#50” manufactured by Toray Industries, Inc., herein indicated as “substrate film 3A”) was used instead of substrate film 1A.

### Comparative Example 3

A substrate film 4A of Comparative Example 3 was prepared in the same manner as in Example 1, except that the pellets prepared in Preparation Example 2 were used instead of the pellets prepared in Preparation Example 1, the molten resin temperature and die temperature were set to 200° C., and the first, second, and third cooling drum temperatures were set respectively to 75° C., 65° C., and 55° C. A protective film for polarizing plate 4E of Comparative Example 3 was prepared in the same manner as in Example 1.

### Performance Evaluation Test of Substrate Film

The photoelastic coefficient, saturated water-absorbing percentage, warpage percentage, and content of volatile components of the substrate films 1A to 4A used in the Example 1 and Comparative Examples 1-3 were measured by the following methods.

### Photoelastic Coefficient

In-plane film retardation was measured using a retardation measuring apparatus (“KOBRA-21ADH” manufactured by Oji Scientific Instruments) while applying a load of 50-150 g to the substrate film. The measured value was divided by the thickness of the film to determine the birefringence Δn. Several values of birefringence Δn were measured while changing the load to prepare a load—Δn curve, of which the inclination was regarded as the photoelastic coefficient.

### Saturated Water-absorbing Percentage

The saturated water-absorbing percentage was determined by measuring a weight increase after one week of dipping at 23° C. according to ASTM D530.

### Warpage Percentage

The substrate film was cut into a square of 100 mm×100 mm. This test specimen was allowed to stand at 60° C. and 95% RH for 500 hours, placed on a horizontal table so that the bottom of the convex is on the table. The distance h (mm) from the surface of the table to the bottom of the test specimen furthest from the table is measured using a caliper. The ratio (%) of the measured distance to the length of the test specimen was determined as the warpage percentage. Specifically, the warpage percentage (%) is determined using the formula: warpage percentage (%)=(h/100)×100.

### Content of Volatile Components

The total amount of the compound with a molecular weight of 200 or less was determined by gas chromatography.

The results of measurement of the water absorption, photoelastic coefficient, warpage percentage, and content of volatile components are shown in Table 1.

### Performance Evaluation Test of Protective Film for Polarizing Plate

Gas barrier properties and adhesion of the protective film for polarizing plate 1E to 4E prepared in Example 1 and Comparative Examples 1-3 were evaluated by the following methods of evaluation. The evaluation results are shown in Table 1.

### Gas Barrier Examination

The oxygen gas permeability and steam permeability of the protective film for polarizing plate were measured using the following measuring devices under the following measuring conditions. The evaluation results are shown in Table 1.

Oxygen gas permeability: Oxygen gas permeability tester (“OX-TRAN 2/20” manufactured by MOCON, Inc.) was used at 23° C. and 90% RH.

Steam permeability: Steam permeability tester (“PERMATRAN-W3/31” manufactured by MOCON, Inc.) was used at 38° C. and 100% RH.

### Adhesion Test

Adhesion of the protective film for polarizing plate as prepared and after the durability test (after standing for 500 hours at 65° C. and 95% RH) was determined by the cross-cut peeling test. 100 cross-cut squares, each having a dimension of 1 mm×1 mm, were produced on the test specimen by drawing perpendicularly crossing 11×11 cut lines on the antifouling layer. A cellophane adhesive tape (manufactured by Sekisui Chemical Co., Ltd.) was applied to the test specimen and perpendicularly drawn to peel off from the surface. The adhesiveness was evaluated by the number of squares which are not peeled off from the test specimen attached to the cellophane adhesive tape. The evaluation results are shown in Table 1.

### Reflectance

Reflection spectrum was measured using a spectrophotometer (“ultraviolet visible near-infrared spectrophotometer V-570” manufactured by Jasco Corp.) at an angle of incidence of 5° to determine reflectance at a wavelength of 550 nm.

### Preparation of Liquid Crystal Display Element

### (1) Preparation of Polarizing Plate with Antireflection Function

A polyvinyl alcohol film with a polymerization degree of 2400 and a thickness of 75 μm was stained by dipping in a staining bath containing iodine and potassium iodide at 40° C. The film was then subjected to a drawing-crosslinking treatment by drawing in an acidic bath containing boric acid and potassium iodide at 60° C. to a total drawing magnification of 5.3 fold. The film was washed with water and dried at 40° C. to obtain a polarizing plate with a thickness of 28 μm.

The above-mentioned polarizing plate was attached to the substrate film side of the protective film for polarizing plate 1E obtained in Example 1 via an acrylics adhesive (“DP-8005 clear” manufactured by Sumitomo 3M). The surface reformed substrate film 1B was attached to the other side of the polarizing plate via an acrylics adhesive, thereby obtaining a polarizing plate with antireflection function 1F. The protective films for polarizing-plate 2E-4E were processed in the same manner to obtain polarizing plates with antireflection function 2F-4F, respectively.

### (2) Preparation of Liquid Crystal Display Element

A front side of a liquid crystal display cell in which a plastic cell substrate was used (3 inches, thickness of the plastic substrate: 400 μm) was attached to the polarizing plate side of each of the polarizing plates with antireflection function 1F-4F. Another polarizing plate was attached to the front side of a liquid crystal display cell thereby obtaining a liquid crystal display element from each of the polarizing plates with antireflection function 1F-4F. The liquid crystal display elements were allowed to stand at 60° C. and 95% RH for 500 hours and placed on a backlight LCD at an illumination intensity of 33,000 Lux to inspect discoloration at the panel end of liquid crystal cell and in-plane color variation of the panel by naked eye observation. The liquid crystal display element was evaluated as good (◯) when no optical leakage was observed near the panel end and a uniform black display was obtained, as fair (Δ) when any optical leakage was observed near the panel end, and as bad (×) when optical leakage at locations apart from the panel end and color variation were observed. The evaluation results are shown in Table 1.

TABLE 1

| | | Comparative Example | | |
|---|---|---|---|---|
| | Example 1 | 1 | 2 | 3 |
| Substrate film | 1A | 2A | 3A | 4A |
| Resin material | a | b | c | d |
| Photoelastic coefficient (×10⁻¹² Pa⁻¹) | 6 | 30 | 50 | 9 |
| Saturated water-absorbing percentage (wt %) | <0.01 | 3.5 | 0.8 | <0.01 |
| Warpage percentage (%) | 0.7 | 6.0 | 4.0 | 3.0 |
| Content of volatile components (wt %) | <0.01 | 6 | 3 | <0.01 |
| Protective film for polarizing plate | 1E | 2E | 3E | 4E |
| Reflectance (%) | 0.40 | 0.50 | 0.50 | 0.50 |
| Adhesion (initial) | 100/100 | 20/100 | 100/100 | 100/100 |
| Adhesion (after durability test *1) | 100/100 | 10/100 | 70/100 | 70/100 |
| Gas barrier properties (oxygen *2) | 0.66 | 3.20 | 1.00 | 0.80 |
| Gas barrier properties (steam *3) | 0.60 | 13.20 | 1.15 | 0.80 |
| Substrate film laminated below the polarizing | 1B | 2B | 3B | 4B |
| plate | | | | |
| Polarizing plate with antireflection function | 1F | 2F | 3F | 4F |
| Display performance | ◯ | Δ | X | Δ |

(Resin material)
a: hydrogenated MTF/TCD/DCP ring-opening copolymer 1
b: triacetylcellulose
c: polyethylene terephthalate
d: hydrogenated DCP/NB ring-opening copolymer 2
*1: 65° C., 95% RH, 500 hours
*2: cm³/m²/day/atm
*3: g/m²/day/atm

It can be seen from Table 1 that the protective film for polarizing plate of Example 1, which has a photoelastic coefficient of less than 9×10⁻¹² Pa⁻¹ and a saturated water-absorbing percentage of less than 0.05% and exhibits a warpage percentage of 1% or less when formed into a film having an average thickness of 50 μm and a dimension of 100 mm×100 mm and allowed to stand at 60° C. and 95% RH for 500 hours, did not curl or deform into a complicated shape after forming an antireflection layer, even if a drying step prior to forming the antireflection layer was omitted. Adhesion with the polarizing plate was also excellent. The protective film for polarizing plate with an antireflection layer formed on the protective film prepared in Example 1 exhibited excellent gas barrier properties. A product obtained by attaching a polarizing plate and incorporating the same into a liquid crystal display apparatus did not show any discoloration at the panel end even after being allowed to stand for a long time under high temperature and high humidity conditions.

On the other hand, the protective films for polarizing plate of Comparative Examples 1 and 2, of which the substrate film has a large photoelastic coefficient and a large saturated water-absorbing percentage and exhibits a large warpage percentage when formed into a film having an average thickness of 50 μm and a dimension of 100 mm×100 mm and allowed to stand at 60° C. and 95% RH for 500 hours, curled after forming an antireflection layer. The curled film must be flattened before attaching to the polarizing plate, requiring a step that impairs process efficiency. The protective film for polarizing plate with an antireflection layer formed thereon of Comparative Example 1 is inferior in gas barrier properties and adhesion. When this protective film is attached to a polarizing plate and incorporated into a liquid crystal display apparatus, the liquid crystal display panel has a defect of optical leakage from near the edge thereof when allowed to stand for a long time under high temperature and high humidity conditions. Although the protective film for polarizing plate of Comparative Example 2 excels in gas barrier properties, the liquid crystal display panel obtained by attaching the protective film to a polarizing plate and incorporating the same into a liquid crystal display apparatus exhibits optical leakage not only from near the edge, but also at locations away from the edge, when allowed to stand for a long time under high temperature and high humidity conditions.

Although the substrate film used in the protective film for polarizing plate of Comparative Example 3 has the same photoelastic coefficient and saturated water-absorbing percentage as the substrate film used in Example 1, this substrate film exhibits a large warpage percentage when formed into a film having an average thickness of 50 μm and a dimension of 100 mm×100 mm and allowed to stand at 60° C. and 95% RH for 500 hours. Because of this, although this protective film for polarizing plate exhibits the same adhesion and gas barrier properties as the protective film for polarizing plate of Example 1, the plate curled after forming an antireflection layer. Therefore, the curled film must be flattened before attaching to the polarizing plate, requiring a step that impairs process efficiency. When this protective film of Comparative Example 3 is attached to a polarizing plate and incorporated into a liquid crystal display apparatus, the liquid crystal display panel has a defect of optical leakage from near the edge thereof when allowed to stand for a long time under high temperature and high humidity conditions.

### INDUSTRIAL APPLICABILITY

A polarizing plate with antireflection function having a structure which causes warpage, deformation, and distortion only with difficulty even if it is placed in an environment of high temperature and high humidity for a long time is provided by the present invention. The protective film for polarizing plate of the present invention excels in adhesiveness.

The method of the present invention can efficiently produce the protective film for polarizing plate of the present invention. Since a substrate film with a small photoelastic coefficient, water-absorbing percentage, and warpage percentage is used in the present invention, the film need not be dried before forming an antireflection layer.

The polarizing plate with antireflection function of the present invention employs the protective film for polarizing plate of the present invention and excels in gas barrier properties. Therefore, a display panel produced by incorporating the polarizing plate with antireflection function of the present invention into a liquid crystal display apparatus of optical articles such as a liquid crystal display can exhibit excellent display performance even when allowed to stand for a long time under high temperature and high humidity conditions.

The optical article of the present invention, equipped with the polarizing plate with antireflection function of the present invention, excels in heat resistance and moisture resistance.

1. A protective film for polarizing plate having a substrate film of a resin material and, laminated on at least one surface thereof directly or via another layer, an antireflection layer, characterized in that the substrate film has a photoelastic coefficient of less than 9×10⁻¹² Pa⁻¹ and a saturated water-absorbing percentage of less than 0.05%, and exhibits a warpage percentage of 1% or less when formed into a film having an average thickness of 50 μm and a dimension of 100 mm×100 mm and allowed to stand at 60° C. and a humidity of 95% for 500 hours.

2. The protective film for polarizing plate according to claim 1, wherein the resin material contains an alicyclic structure-containing polymer.

3. The protective film for polarizing plate according to claim 1 or 2, wherein the antireflection layer is a single layer or multilayer film with two or more layers of an inorganic oxide.

4. A method for preparing the protective film for polarizing plate according to claim 1, comprising a step of forming an antireflection layer on the surface of a substrate film made of a resin material or on the surface of any layer formed on the substrate film, characterized in that the antireflection layer is formed by an ion-plating method, sputtering method, vacuum evaporation method, electroless plating method, electroplating method, or a combination of two or more of these methods.

5. The method for preparing the protective film for polarizing plate according to claim 4, wherein the step of forming an antireflection layer comprises sequentially laminating two or more thin layers of inorganic oxide on the surface of a substrate film or on the surface of any layer formed on the substrate film, wherein the substrate film, with or without any other layer formed thereon, is preferably caused to pass through a series of film-forming chambers, each equipped with a means for forming a thin layer of inorganic oxide, whereby two or more thin layers of inorganic oxide are sequentially formed on the surface of the substrate film or on the surface of any layer formed on the substrate film.

6. The method for preparing the protective film for polarizing plate according to claim 4, wherein the substrate film is made from a resin material containing an alicyclic structure-containing polymer.

7. A polarizing plate with antireflection function comprising a polarizing plate laminated on one side of the substrate film of the protective film for polarizing plate according to claim 1 on which the antireflection layer is not provided.

8. An optical article equipped with the polarizing plate with antireflection function according to claim 7.
